(19) United States
(12) Patent Application Publication
(10) Pub. No.: US 2003/0166360 A1
(43) Pub. Date: Sep. 4, 2003

(54) Apparatus for storing interchangeable modules and method of manufacturing the same

(76) Inventors: Bradley A. Thornton, Bainbridge Island, WA (US); David J. Canning, Bainbridge Island, WA (US)

Correspondence Address: Frank J. Bozzo, BLACK LOWE & GRAHAM, 816 Second Avenue, Seattle, WA, 98104, US

(21) Appl. No.: 10/320,883

(22) Filed: Dec. 16, 2002

Related U.S. Application Data
(60) Provisional application No. 60/341,162, filed on Dec. 15, 2001.

(51) Int. Cl. H01R 24/00

(52) U.S. Cl. 439/630

(57) ABSTRACT

An apparatus and method for storing at least one interchangeable module within an existing storage space is disclosed. The apparatus includes a core layer having two substantially parallel planar faces and a layer thickness approximately as large as a module thickness of an interchangeable module between the planar faces, the core layer being shaped for receiving an interchangeable module. The apparatus further includes a plurality of side pieces sized to substantially cover the core layer and the opening formed in the core layer such that when the side pieces are disposed against the planar faces the side pieces enclose the opening on sides parallel with the planar faces with an only access point to the opening being in the first edge of the core layer. A securing component joins the side pieces to the core layer.

### PRIORITY CLAIM

This invention claims priority from United States Provisional Application No. 60/341,162 filed Dec. 15, 2001.

### FIELD OF THE INVENTION

This invention relates generally to storage containers, and more specifically, to an apparatus for storing interchangeable electronics modules used with personal electronic devices.

### BACKGROUND OF THE INVENTION

Personal electronic devices such as notebook computers, personal digital assistants, handheld computers, digital cameras, cellular telephones, and other devices increasingly are becoming more powerful and more prevalent. The proliferation of these devices has been made possible by the ever-improving price-performance of microelectronic components. The improved price-performance of components ranging from microprocessors to memory chips and from storage units to communications units allows personal electronic devices to be more useful and more user friendly. As a result, users of personal electronic devices are becoming increasingly more dependent on these personal electronic devices.

The proliferation of these devices has created an increasing demand for personal electronic devices to be more versatile. To name one example, users no longer want to be limited to the built-in memory storage in their digital cameras. Users want to be able to swap out a storage module and replace it with another to record more images. This is analogous to film-based cameras, wherein users can change rolls of film without having to stop to upload stored images to a computer or, other device. Similarly, digital camera users might wish to couple interchangeable storage modules in a computer or a printer for viewing or printing previously-captured images, respectively, without having to upload the image data from the camera to the other device.

To name a second example, users of personal digital assistants want to be able to swap out modules storing data and software applications, and want to add hardware functionality to their handheld computers, such as camera modules just as computer users can add functions by adding cards or boards to a motherboard. Also, people who use personal digital assistants and cellular telephones want those devices to be able to interact. For example, BlueTooth® enabled devices allow phone numbers or text messages to be wirelessly transmitted from handheld computers to a cellular telephone, and then telephonically sent to another user.

These functions are supported by today's small yet powerful digital modules, such as SD (secure digital) cards, smart media cards, memory sticks, and similar interchangeable modules. SD cards, smart media cards, and memory sticks can augment the functionality of portable electronic devices in many ways. For example, these modules can be used for adding memory for storage of applications and data applications. Data can be swapped in and out simply by inserting and removing modules from an appropriate socket on the personal electronic device. Similarly, these modules provide for read-only memory (ROM) program storage to add applications to personal digital assistants. In addition, communications capability, such as BlueTooth® enabling modules or other telecommunications devices, can be added to a handheld computer through the insertion of an SD card into an appropriate socket on the handheld device. These modules greatly enhance the versatility, upgradeability, and convenience of personal electronic devices.

However, interchangeability of SD cards, smart media cards, and memory sticks presents a concern. A user may have multiple small interchangeable SD cards, smart media cards, and memory sticks which, because of their small size, are susceptible to loss or damage. The SD cards, smart media cards, and memory sticks can easily be stored in a pocket, purse, or other form of personal storage, but dropping an SD card, smart media card, or a memory stick in such a receptacle does nothing to protect the module from accidentally being dropped from that receptacle or damaged while inside that receptacle. Cases for digital devices may provide storage pockets for these modules, but having to carry the cases may make carrying the digital devices more cumbersome, impairing the enjoyment of the devices.

Thus, there is an unmet need in the art for an apparatus for storing and protecting SD cards, smart media cards, memory sticks, or similar modules for a personal electronic device, without requiring users to carry along an additional carrying case for the personal electronic device.

### SUMMARY OF THE INVENTION

The present invention is an apparatus for storing and protecting small electronics modules such as secure digital (SD) cards, smart media cards, and memory sticks, and a method for making the same. One embodiment of the present invention is an approximately credit-card sized body comprised of a conjoined core layer and side pieces having at least one opening formed in the core layer which can slidably receive a small electronics module such as an SD card, smart media card, or a memory stick. The resulting apparatus can thereby safely store the small electronics module in a credit-card sized storage slot in a wallet, purse, briefcase, organizer or other carrying device the user of a personal digital device making use of the modules might carry. Thus, the user can protect small electronics modules without having to carry a separate storage case.

One exemplary embodiment of the present invention for storing at least one interchangeable module within an existing storage space includes a core layer. The core layer features two substantially parallel planar faces and a layer thickness substantially as large as a module thickness of an interchangeable module between the planar faces. The core layer is shaped for receiving an interchangeable module. The apparatus further includes a plurality of side pieces sized to substantially cover the core layer and the opening formed in the core layer. When the side pieces are disposed against the planar faces, the side pieces enclose the opening on sides parallel with the planar faces with an only access point to the opening being in the first edge of the core layer. A securing component joins the side pieces to the core layer.

Embodiments of the present invention may have one or more openings, and the openings each may be large enough to accommodate secure digital cards, smart media cards, BlueTooth® cards, memory sticks, or other interchangeable modules. The core layer and the side pieces each may be composed of a same material, such as a vinyl plastic, or the core and side pieces may be composed of different materials. The core layer and the side pieces may be joined by a glue, a sheet adhesive, or by welding. Text and/or images may be imprinted on outward-facing surfaces of one or both of the side pieces. In one embodiment, the assembled apparatus is sized to fit in an existing storage space designed to accommodate a credit card.

### BRIEF DESCRIPTION OF THE DRAWINGS

The preferred and alternative embodiments of the present invention are described in detail below with reference to the following drawings.

FIG. 1A is an exploded perspective diagram of sheets of core material sheet and adhesive material used in forming of an embodiment of the present invention;

FIG. 1B is a perspective diagram of a sheet of core material to which sheets of adhesive material have been attached;

FIG. 1C is the perspective diagram of FIG. 1B with the joined sheets of core material and adhesive material shown in FIG. 1B with openings cut from the joined sheets;

FIG. 1D is an exploded perspective diagram of the joined and cut sheets of FIG. 1C with sheets of side piece material positioned to be attached;

FIG. 1E is a perspective diagram of the joined and cut sheets of FIG. 1C to which the side piece material sheets have been attached;

FIG. 1F is a perspective diagram of the joined sheets of FIG. 1E with an apparatus of the present invention cut from the joined sheets;

FIG. 2A is a perspective diagram of an assembled apparatus of an embodiment of the present invention;

FIG. 2B is a top view of an assembled embodiment of an apparatus;

FIG. 2C is a side view of an assembled embodiment of an apparatus; and

FIG. 3 is a flowchart of a method of the present invention.

### DETAILED DESCRIPTION OF THE INVENTION

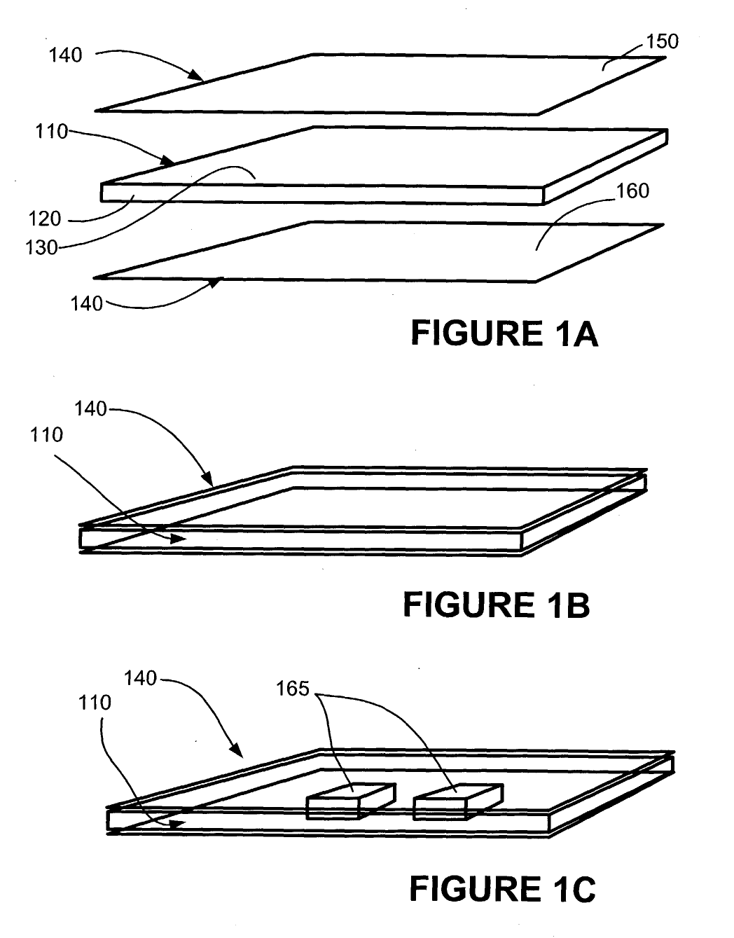

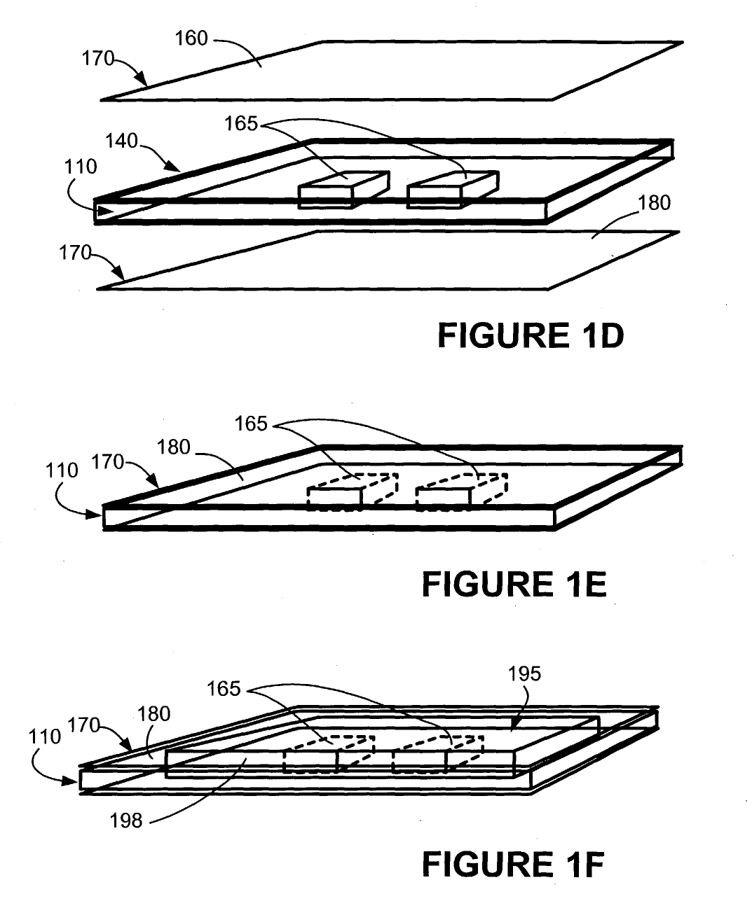

According to one presently preferred embodiment of the present invention, forming an apparatus of the present invention commences a sheet of core material 110 and sheets of adhesive material 140 as shown in FIG. 1A. A thickness of the edge 120 of the core material 110 must be approximately as thick as a module which the apparatus will store. As will be appreciated, the core material 110 has to be approximately as thick as the module to be stored by the apparatus so that the module can fit in the opening formed by internal sides of the core material 110 and the side pieces 170 (FIGS. 1D, 1E, and 1F). At the same time, it may be desired for the core material 110 to have a thickness slightly less than a module thickness such that the side pieces 170 (FIGS. 1D, 1E, and 1F) will engage sides of the modules to secure the modules in the apparatus to prevent them from falling out. As far as the choice of the core material 110, for example, one embodiment of the present invention which suitably is used to store one or more secure digital (SD) cards (not shown), the core material is a sheet of vinyl plastic having a thickness at the edge 120 of 60 mils. A variety of materials can be used as core material, including other plastics, lightweight metals, heavyweight papers, ceramics, or other materials, which may be selected on the basis of weight, rigidity, or other result-oriented concerns.

FIG. 1A also shows two sheets of double-faced adhesive 140. In one presently preferred embodiment, the adhesive sheets are comprised of 3M® 468 double-sided adhesive. The sheets of double-sided adhesive material 140 are used to join sections of the core material 110 to side pieces 170 (FIGS. 1C, 1D, and 1E) as will be explained below. The sections of core material 110 could also be joined to the side pieces 170 using liquid adhesives, such as glues or epoxies, or by welding suitable materials together, such as by heat welding if suitable plastics are used for the core material 110 and the side pieces 170.

In one presently preferred embodiment, backing sheets (not shown) of the adhesive material 140 are removed from inward-facing sides 160 of the adhesive material 140 which face planar faces 130 of the core material 110. The inward-facing sides 160 of the adhesive material 140 are applied to the planar faces 130 of the core material 110. The resulting joined sheets are shown in FIG. 1B. For the time being, backing sheets (not shown) on an outward-facing sides 160 of the adhesive material 140 are left in place to facilitate further handling of the joined sheets of core material 110 and adhesive material 140.

In one presently preferred embodiment, holes 165 are cut through the joined sheets of core material 110 and adhesive material 140 which will form the openings which will receive modules to be stored by the apparatus. As will be explained further below, these holes 165 may have different widths and lengths in the same apparatus or in different production runs of the apparatus to accommodate different sizes of modules to be stored therein. Cutting these holes 165 at this stage of the production of the apparatus simplifies assembly of the apparatus, as will be appreciated below. FIG. 1C shows two holes 165 for an embodiment of the apparatus that suitably receives two modules.

Different interchangeable modules have different sizes, and thus require different sizes of openings be formed in the core material 110, and the core material 110 be chosen with an appropriate thickness. For example, a secure digital or multimedia card, such an opening should have dimensions of approximately 24 millimeters by 33 millimeters, and the layer thickness is approximately 30 mils. For a BlueTooth® card, while the thickness is the same, the opening should have dimensions of approximately 24 millimeters by 51 millimeters. For a memory stick, a core material 110 thickness of approximately 90 mils, and an opening of approximately 21.5 millimeters by 50 millimeters is required. For a smart media card, a core material 110 thickness of 20 mils is required, and the opening formed should have dimensions of approximately 45 millimeters by 37 millimeters.

In a production run for an embodiment of the present invention, the core material 110 and the adhesive material 140 are presented in twelve-inch by eight-inch sheets, each of which can provide for nine credit-card-sized apparatus. However, in FIGS. 1A through 1F, the construction of a single apparatus is shown for clarity of illustration. Also, in one presently preferred embodiment, the holes 165 are die-cut from the joined layers. However, as will be appreciated by one ordinarily skilled in the art, other cutting techniques suitably may be used to form the holes 165.

In FIG. 1D, the joined sheets of core material 110 and adhesive material 140 with holes 165 cut therefrom are shown with sheets of side piece material 170 in position to be installed. Although not shown in the figures, one or more of the sheets of side piece material 170 may be imprinted with text and/or images (not shown) for reference, promotional, or other purposes on one or both outer-facing sides 160 of the sheets of side piece material 170. Similarly, a side piece material 170 may be selected that allows a user of the apparatus to write on it. As previously described, if multiple apparatuses are to be formed at one time, multiple sets of text and/or images suitably are imprinted on the outer-facing sides 160 of the side piece material 170 positioned to fit sides of finished apparatuses. Also, as will be appreciated by one ordinarily skilled in the art, once imprinted, the sheets of side piece material 170 may be layered with a protective sheet or coating (not shown) to protect the imprinted text and/or graphics during remaining phases of manufacture and subsequent distribution.

To attach the sheets of side piece material 170 to the previously joined sheets of core material 110 and adhesive material 140, backing sheets (not shown) on outer-facing sides 150 of the sheets of adhesive material 140 are removed. Sheets of side piece material 170 then are guided in place over the outer-facing sides 150 of the sheets of adhesive material 140 then pressed into place. Once pressed into place, the joined sheets of core material 110, adhesive material 140, and side piece material 170 appear as shown in FIG. 1E. The holes 165 previously cut into the joined sheets of core material 110 and adhesive material 140 are now closed along the planar faces 130 of the core material by the sheets of side material 170. As will be appreciated by one ordinarily skilled in the art, the sheets of the side piece material 170 may be guided into place by aligning the sheets against a set of guides before pressing them into place. Also, as previously described, the sheets of side material 170 could be joined to the sheet of core material 110 using other forms of attachment.

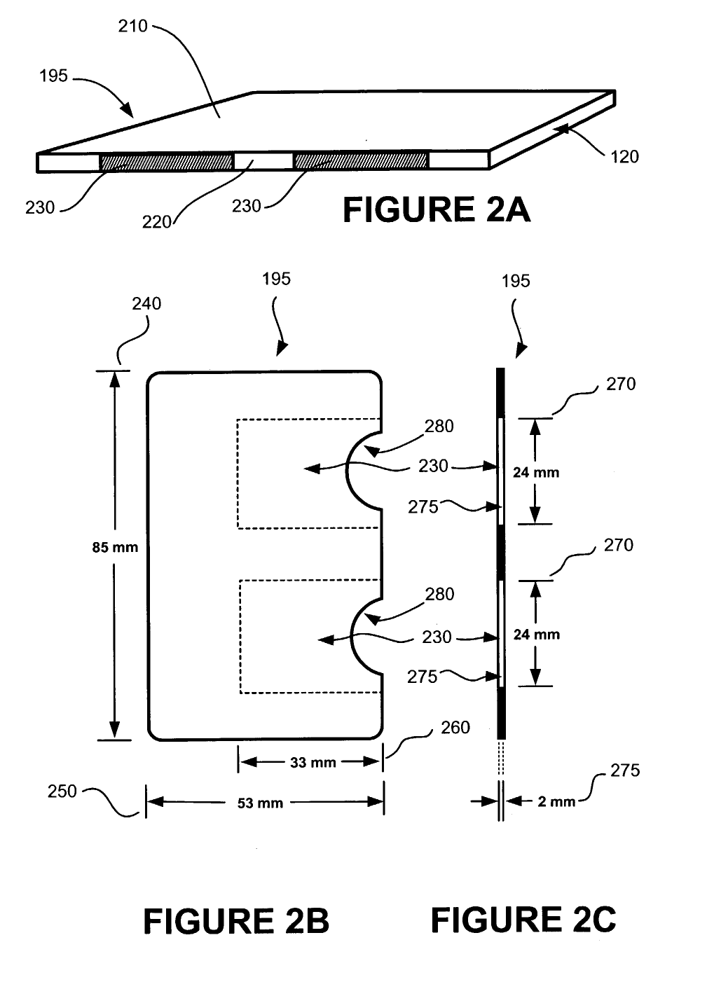

Once all the sheets 110, 140, and 170 have been joined, an apparatus 195 according to an embodiment of the present invention can be cut from the joined sheets. In one presently preferred embodiment, the core layers are cut from the joined sheets 110, 140, and 170 using high pressure water jet cutting. As is understood in the art, the water jets suitably are driven on a computer-controlled water cutting table. High pressure water cutting tends to leave edges 120 of the joined layers smooth, thus diminishing the degree of finishing that would be left if the apparatus 195 were cut from the joined sheets 110, 140, and 170 using other techniques, such as jig-sawing. Nonetheless, other suitable ways of cutting the apparatus from the joined layers 110, 140, and 170 can be used. Also, notches to facilitate removal of modules from the apparatus may be cut along an outer edge of the holes 165 (FIGS. 1C, 1D, 1E, and 1F), as described below in connection with FIG. 2B.

The resulting apparatus 195 is shown in FIGS. 2A, 2B, and 2C. FIG. 2A shows a perspective diagram of the apparatus 195. Cut sections of outer facing sides 180 of the side material 170 (FIGS. 1D, 1E, and 1F) now comprise sides 210 of the apparatus. Text and/or images previously imprinted on the sheets of side material 170 (FIGS. 1D, 1E, and 1F) now appear on the sides 210 of the apparatus 195. The apparatus 195 has a thickness 120 which, as previously described, suitably was chosen to accommodate the modules to be stored by the apparatus 195. In a front edge 220 of the apparatus 195 according to one presently preferred embodiment of the present invention are two slots 230, each of which can receive and store an interchangeable module (not shown).

FIG. 2B shows a top view of the apparatus 195 and dimensions of one presently preferred embodiment. The presently preferred embodiment has a length 240 of about 85 millimeters or about 3.375 inches and a width 250 of about 53 millimeters or about 2.125 inches. The length 240 and width 250 correspond approximately with that of a standard credit card. Thus, the apparatus 195 can fit within a storage pocket designed to fit a credit card, such as are commonly found in wallets, purses, briefcases, organizers, and other personal items people commonly carry.

In one presently preferred embodiment of the apparatus 195, the module storage slots 230 have a depth 260 of about 33 millimeters or about 1.44 inches. As shown in FIG. 2C, the slots 230 have a width 270 of about 24 millimeters or about 0.98 inches. An interior thickness 275 of the apparatus 295 is 60 mils, which is the thickness 120 of the sheet of core material 110 (FIGS. 1A through 1F). The depth 260, width 270, and thickness 275 shown are sufficient to receive interchangeable modules such as a secure digital (SD) card, a multimedia card, or another interchangeable module of like size. In other embodiments, the depth 260, width 270, and thickness 275 can be selected to accommodate other interchangeable modules such as compact flash cards, smart media cards, memory sticks, or other media types of other sizes.

Also, as shown in FIG. 2B, notches 280 may be formed in the side pieces 210 to facilitate the gripping and thus the insertion and/or removal of interchangeable modules from the apparatus. These notches 280 can be cut from the side pieces 210 when the apparatus is being cut from the joined sheets 110, 140, and 170 as described in connection with FIG. 1F.

It will be appreciated by one ordinarily skilled in the art that embodiments of the present invention may be formed in a wide range of sizes to accommodate other types of modules or other media. The structure of the apparatus 195 can be sized and shaped to fit organizer binders and other binders, business card cases, and other such cases and many other shapes. As also will be appreciated, the slots 230 (FIGS. 2A, 2B, and 2C) could be arrayed along multiple edges of the apparatus, and one, two, or more slots 230 could be formed in each of the apparatuses 195, the slots 230 being of equivalent or different sizes in the same apparatus 195. It also will be appreciated that the apparatus 195 is not limited to storing interchangeable digital media, but could be used for storing any form of small item that it is desired to store securely in storage pockets of larger devices, such as small pieces of toys.

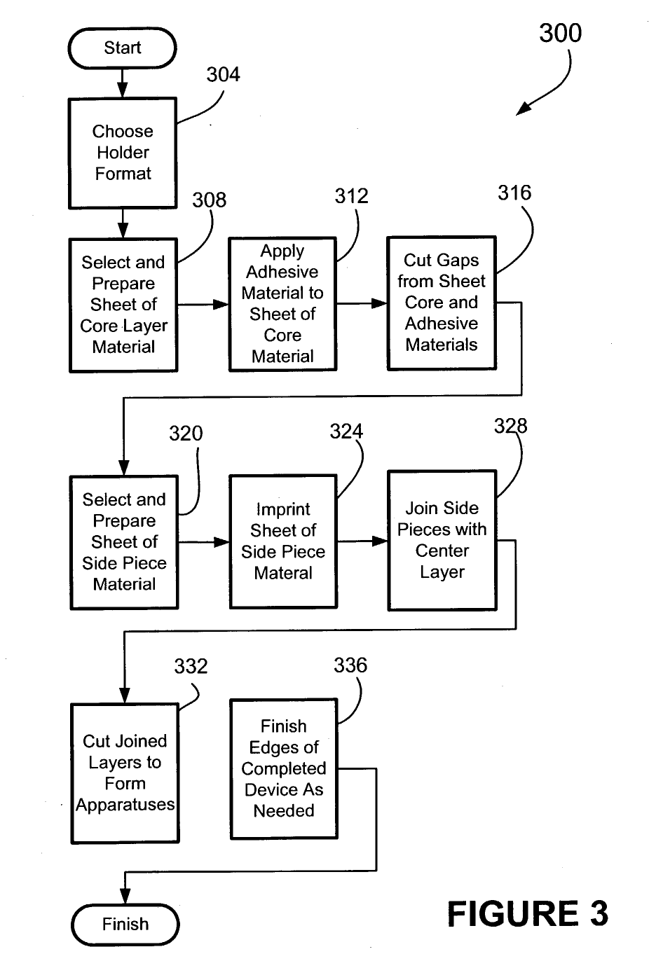

FIG. 3 shows a flowchart of a method 300 for making the storage apparatus previously described is summarized in flowchart form in. At a block 304, the format of the apparatus, such as its exterior dimensions, what type and thus what size modules it will hold, how many modules, and other parameters. At a block 308, a core material is chosen for its rigidity and other considerations, and the material is prepared in a sheet form for production of apparatuses. In one preferred embodiment of the present invention, at a block 312 adhesive in the form of sheets or liquids is applied to outer facing sides of the sheets of core material. At a block 316, openings that will form the slots for receiving and storing modules are cut from the core material and adhesive construct.

With the core material processed to form a core of an apparatus, at a block 320, sheets of side material are selected and prepared. Side materials may be of different compositions, whether metal, plastic, paper, ceramic, or another material. At a block 324, the side materials are imprinted as desired with advertising or other information. At a block 328, the side materials are joined to the core material using adhesives or welding as previously described.

With the layers assembled, at a block 332 the layers are cut to form one or more apparatuses. At a block 336, edges of the apparatuses cut from the layers are finished as desired.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. An apparatus for storing at least one interchangeable module within an existing storage space, the apparatus comprising:
a core layer having two substantially parallel planar faces and a layer thickness approximately as large as a module thickness of an interchangeable module between the planar faces, the core layer being shaped for receiving an interchangeable module within an edge of the core layer by removing an interior portion of the core layer such that remaining interior surfaces perpendicular to the planar faces define an opening closed on all but a first edge of the planar section, the opening being large enough to substantially accommodate a module length and a module width of the interchangeable module;
a plurality of side pieces sized to substantially cover the core layer and the opening formed in the core layer such that when the side pieces are disposed against the planar faces the side pieces enclose the opening on sides parallel with the planar faces with an only access point to the opening being in the first edge of the core layer; and
a securing component joining the side pieces to the core layer.

2. The apparatus of claim 1, wherein the opening has interior dimensions of approximately 24 millimeters by 33 millimeters, and the layer thickness is approximately 30 mils such that one of a secure digital card or a multimedia card is suitably accommodated in the opening.

3. The apparatus of claim 1, wherein the opening has interior dimensions of approximately 21.5 millimeters by 50 millimeters, and the layer thickness is approximately 90 mils such that a memory stick is suitably accommodated in the opening.

4. The apparatus of claim 1, wherein the opening has interior dimensions of approximately 45 millimeters by 37 millimeters, and the layer thickness is approximately 20 mils such that a smart media card is suitably accommodated in the opening.

5. The apparatus of claim 1, further comprising removing an additional interior portion of the core layer such that remaining interior surfaces perpendicular to the planar faces define two openings.

6. The apparatus of claim 1, wherein at least one of the side pieces includes a notch, the notch being formed through the side piece thickness adjacent the first edge at a point where the side pieces extend over the opening formed in the core layer.

7. The apparatus of claim 1, wherein the core layer and the side pieces are composed of vinyl plastic.

8. The apparatus of claim 1, wherein the core layer is composed of a first material and the side pieces are composed of a second material, the second material being a different material than the first material.

9. The apparatus of claim 1, wherein the securing component includes one of a glue or a sheet adhesive.

10. The apparatus of claim 1, wherein the securing component includes a weld between materials comprising the core layer and the side pieces.

11. The apparatus of claim 1, wherein at least one of the side pieces bears one at least one of a text or visual image on an outward-disposed face, the outward-disposed face being opposite an inward-disposed face at which the at least one side piece and the core layer are joined by the securing component.

12. The apparatus of claim 1, wherein the existing storage space includes a credit-card pocket.

13. An apparatus for storing within an existing storage space at least one interchangeable module, the apparatus comprising:
a core layer having a core thickness on opposing sides of which are two substantially parallel planar faces, the core layer having a core width and a core length, the core width and the core length being sized to fit within the existing storage space, the core thickness also being approximately as large as a module thickness of the interchangeable module and having an interior portion of the planar section removed such that remaining interior surfaces perpendicular to the planar faces define an opening closed on all but a first edge of the core layer, the opening having interior dimensions large enough to substantially accommodate a module length and a module width of the interchangeable module;
a pair of side pieces, each of the side pieces having a side piece width substantially the same as the core width, a side piece length substantially the same as the core length, and a side piece thickness such that a combined thickness of the side pieces and the core thickness are sized to fit within the existing storage space and the side pieces enclose the opening on sides parallel with the planar faces with an only access point to the opening being in the first edge of the core layer; and
a securing component, the securing component joining the planar faces of the core layer with inward facing surfaces of the side pieces.

14. The apparatus of claim 13, wherein the opening has interior dimensions of approximately 24 millimeters by 33 millimeters, and the core thickness is approximately 30 mils such that one of a secure digital card or a multimedia card is suitably accommodated in the opening.

15. The apparatus of claim 13, wherein the opening has interior dimensions of approximately 21.5 millimeters by 50 millimeters, and the core thickness is approximately 90 mils such that a memory stick is suitably accommodated in the opening.

16. The apparatus of claim 13, wherein the opening has interior dimensions of approximately 45 millimeters by 37 millimeters, and the core thickness is approximately 20 mils such that a smart media card is suitably accommodated in the opening.

17. The apparatus of claim 13, further comprising removing an additional interior portion of the core layer such that remaining interior surfaces perpendicular to the planar faces define two openings.

18. The apparatus of claim 13, wherein at least one of the side pieces includes a notch, the notch being formed through the side piece thickness at a side piece edge at a point where the side piece extends over the at least one opening.

19. The apparatus of claim 13, wherein the core layer and the side pieces are composed of vinyl plastic.

20. The apparatus of claim 13, wherein the core layer is composed of a first material and the side pieces are composed of a second material, the second material being a different material than the first material.

21. The apparatus of claim 13, wherein the securing component is one of a glue or a sheet adhesive.

22. The apparatus of claim 13, wherein the securing component is a weld between materials comprising the core layer and the side pieces.

23. The apparatus of claim 13, wherein at least one of the side pieces bears one at least one of a text or visual image on an outward-disposed face, the outward-disposed face being opposite an inward-disposed face at which the at least one side piece and the core layer are joined by the securing component.

24. The apparatus of claim 13, wherein the existing storage space is a credit-card pocket.

25. An apparatus for storing within a credit-card pocket at least one interchangeable electronics module for a portable electronics device, the apparatus comprising:
a core layer having a core thickness on opposing sides of which are two substantially parallel planar faces, the core layer having a core width and a core length, the core width and the core length being sized to fit within a credit-card sized pocket, the core thickness also being approximately as large as a module thickness of the interchangeable electronics module and having an interior portion of the planar section removed such that remaining interior surfaces perpendicular to the planar faces define an opening closed on all but a first edge of the core layer, the opening having interior dimensions large enough to substantially accommodate a module length and a module width of the interchangeable electronics module;
a pair of credit-card sized side pieces having a side piece thickness such that a combined thickness of the side pieces and the core thickness are sized to fit within the credit-card sized pocket and the side pieces enclose the opening on sides parallel with the planar faces with an only access point to the opening being in the first edge of the core layer; and
a securing component, the securing component joining the planar faces of the core layer with inward facing surfaces of the side pieces.

26. The apparatus of claim 25, wherein the opening has interior dimensions of approximately 24 millimeters by 33 millimeters, and the core thickness is approximately 30 mils such that one of a secure digital card or a multimedia card is suitably accommodated in the opening.

27. The apparatus of claim 25, wherein the opening has interior dimensions of approximately 21.5 millimeters by 50 millimeters, and the core thickness is approximately 90 mils such that a memory stick is suitably accommodated in the opening.

28. The apparatus of claim 25, wherein the opening has interior dimensions of approximately 45 millimeters by 37 millimeters, and the core thickness is approximately 20 mils such that a smart media card is suitably accommodated in the opening.

29. The apparatus of claim 25, further comprising removing an additional interior portion of the core layer such that remaining interior surfaces perpendicular to the planar faces define two openings.

30. The apparatus of claim 25, wherein at least one of the side pieces includes a notch, the notch being formed through the side piece thickness at a side piece edge at a point where the side piece extends over the at least one opening.

31. The apparatus of claim 25, wherein the core layer and the side pieces are composed of vinyl plastic.

32. The apparatus of claim 25, wherein the core layer is composed of a first material and the side pieces are composed of a second material, the second material being a different material than the first material.

33. The apparatus of claim 25, wherein the securing component is one of a glue or a sheet adhesive.

34. The apparatus of claim 25, wherein the securing component is a weld between materials comprising the core layer and the side pieces.

35. The apparatus of claim 25, wherein at least one of the side pieces bears one at least one of a text or visual image on an outward-disposed face, the outward-disposed face being opposite an inward-disposed face at which the at least one side piece and the core layer are joined by the securing component.

36. A method for making an apparatus for storing at least one module within an existing storage space, the method comprising:
forming a core layer having a layer thickness on opposing sides of which are two substantially parallel planar faces, the core layer having a core width and a core length, the core width, and the core length being sized to fit within the existing storage space, the core thickness also being large enough to slidably receive a module thickness of the module;
forming the core layer such that interior sides of the core layer perpendicular to the planar faces define at least one opening through the core layer and the planar faces, the opening being adjacent to at least one edge of the core layer, the opening having an opening width and an opening depth large enough to substantially accommodate the module;
forming a pair of side pieces, each of the side pieces having a side piece width substantially the same as the core width, a side piece length substantially the same as the core length, and a side piece thickness such that a combined thickness of the side pieces and the core thickness are sized to fit within the existing storage space; and
joining the planar faces of the core layer with inward facing faces of the side pieces.

37. The method of claim 36, wherein the opening formed has interior dimensions of approximately 24 millimeters by 33 millimeters, and the layer thickness is approximately 30 mils such that one of a secure digital card or a multimedia card is suitably accommodated in the opening.

38. The method of claim 36, wherein the opening formed has interior dimensions of approximately 21.5 millimeters by 50 millimeters, and the layer thickness is approximately 90 mils such that a memory stick is suitably accommodated in the opening.

39. The method of claim 36, wherein the opening formed has interior dimensions of approximately 45 millimeters by 37 millimeters, and the layer thickness is approximately 20 mils such that a smart media card is suitably accommodated in the opening.

40. The method of claim 36, further comprising forming in the core layer such that the interior sides of the core layer define at least two openings in the core layer.

41. The method of claim 36, further comprising forming in at least one of the side pieces a notch, the notch being formed through the side piece thickness at a side piece edge at a point where the side piece extends over the at least one opening.

42. The method of claim 36, wherein the core layer and the side pieces are formed from vinyl plastic.

43. The method of claim 36, wherein the core layer is formed from a first material and the side pieces are formed from a second material, the second material being different from the first material.

44. The method of claim 36, wherein the planar faces of the core layer are joined with inward facing faces of the side pieces using one of a glue or a sheet adhesive.

45. The method of claim 36, wherein the planar faces of the core layer are joined with inward facing faces of the side pieces by welding.

46. The method of claim 36, further comprising creating at least one text or visual image on at least one of the side pieces on an outward-disposed face, the outward-disposed face being opposite an inward-disposed face at which the at least one side piece and the core layer are joined.

47. The method of claim 36, further comprising finishing edges of the joined core layer and side pieces to smooth any roughness on the edges.

48. The method of claim 36, wherein the existing storage space is a credit-card pocket.
